(19) United States
(12) Patent Application Publication
(10) Pub. No.: US 2026/0177221 A1
(43) Pub. Date: Jun. 25, 2026

(54) Illumination Device For Visibly Displaying An Ornament

(71) Applicant: Marelli Germany GmbH, Reutlingen (DE)

(72) Inventors: Martin Licht, Reutlingen (DE); Matthias Raible, Geislingen (DE)

(73) Assignee: Marelli Germany GmbH, Reutlingen (DE)

(21) Appl. No.: 19/427,267

(22) Filed: Dec. 19, 2025

(30) Foreign Application Priority Data
Dec. 19, 2024 (DE) 102024138824.2

(51) Int. Cl. F21S 43/31; F21S 43/10; F21S 43/33

(52) U.S. Cl. CPC F21S 43/31; F21S 43/10; F21S 43/33

(57) ABSTRACT

The invention relates to an illumination device for a motor vehicle, for the visible display of at least one ornament. The illumination device includes a plurality of light units with light sources for generating light and with at least one light exit region. At least one light-transparent cover element closes the at least one light exit region. The light-transparent cover element, with respect to an optical axis (A) of the illumination device, is arranged outside a radar encoupling surface of at least one radar-transparent portion for encoupling radar beams; and the at least one radar-transparent portion with the radar encoupling surface is provided for encoupling the radar radiation.

### CROSS-REFERENCE TO RELATED APPLICATIONS

The present application claims priority to and all the benefits of German Patent Application No. 102024138824.2, filed on Dec. 19, 2024, the entire contents of which are hereby expressly incorporated herein by reference.

### BACKGROUND OF THE INVENTION

### 1. Field of the Invention

The invention relates to an illumination device, in particular for a motor vehicle, for visibly displaying at least one ornament.

### 2. Description of the Related Art

Illumination devices for motor vehicles are known from the prior art, wherein an ornament, e.g., a lettering or a logo, is to be highlighted by the illumination. In this case, however, this can lead to undesirable heat generation and/or air currents, which impairs operation and, in particular, the radiated light distribution for visibly displaying the ornament.

If, in addition to a light source, a radar device is also to be operated as a component of the illumination device, the cooling requirements increase, in particular for the radar device. Therefore, the radar device is usually arranged in a region accessible to air so that air flows around the radar device during operation, and it is thereby cooled. If the light source is arranged in a common, airtight housing with the radar device, overheating of the light source and/or the radar device may occur. However, if the housing is not designed airtight, the air currents can disrupt the illumination and impair the quality of the visible display of the ornament.

In contrast, the introduction of the light via a light guide requires additional elements such that the construction can be more complicated and more expensive overall.

The object of the invention is therefore to create an illumination device in which the aforementioned disadvantages are avoided, and, in particular, overheating of light sources and/or the radar device is avoided. Furthermore, the light sources and/or the light path are to be protected from air currents. Furthermore, this is to provide an alternative and/or supplement to the use of fiber optics.

### SUMMARY OF THE INVENTION

The object of solving the problems existing in the prior art is achieved according to the invention by an illumination device for a motor vehicle, for visibly displaying at least one ornament. The illumination device comprises a plurality of light units with light sources for generating light. Furthermore, the light units each have at least one light exit region, wherein at least one light-transparent cover element closes the at least one light exit region. The light-transparent cover element is, with respect to an optical axis of the illumination device, arranged outside a radar encoupling surface of at least one radar-transparent portion for encoupling radar beams. Furthermore, the illumination device has at least one radar-transparent portion with the radar encoupling surface for encoupling the radar radiation. The radar-transparent portion comprises at least one light encoupling surface for encoupling the light emitted by the light units and a decoupling surface for decoupling the encoupled radar radiation and for emitting a light distribution which represents the at least one ornament, depending upon the light coupled into the radar-transparent portion via the light encoupling surfaces. This protects the light sources from air currents, especially those used to cool a radar device. The illumination device can be operated together with the radar device, thereby avoiding overheating. In particular, the light-transparent cover element separates the light sources from the radar device in terms of flow such that an airflow between the light sources and the radar device or the radar-transparent portion is avoided.

The light encoupling surface describes the surface via which the light generated by the light source is coupled into the radar-transparent portion. In one embodiment, the light encoupling surface extends-in a direction transverse, in particular perpendicular, to the optical axis-at least partially, and in one embodiment completely, between two light units, diametrically opposite with respect to the optical axis, along an inner side of the radar-transparent portion which is oriented towards the radar chamber and/or radar device.

Accordingly, the radar encoupling surface is understood here to be a surface via which radar radiation emanating from the radar device is coupled into the radar-transparent portion. The radar encoupling surface extends at least regionally on the inside of the radar-transparent portion, at least across the width—i.e., transversely, in particular perpendicular. to the optical axis-of the radar device.

In one embodiment, the radar encoupling surface and the light encoupling surface overlap at least regionally, and in another embodiment, completely. In one embodiment, the entire inner side of the radar-transparent portion which delimits the radar chamber is designed as a light encoupling surface and/or radar encoupling surface.

In this context, a light-transparent cover disc is understood to be, in one embodiment, a cover disc that is largely transparent to light. The cover disc can therefore also be semi-transparent. The cover disc can have high level of transparency of at least 80% in one embodiment, and at least 90% in another embodiment, and at least 95% in still another embodiment.

The radar-transparent portion is preferably also transparent to light, wherein the same transparency values as for the cover discs can be provided here. However, lower transparency values are also preferred here according to alternative embodiments, as long as the visibility of the ornament is ensured. Preferred transparency values for light, i.e., in the optical spectral range, are at least 40%, preferably at least 70%, preferably at least 90%. It is also possible for the radar-transparent portion to have a frosted coating for light in order to thereby make the visibility of an ornament inserted into or applied to the radar-transparent section appear less glaring.

The ornament, e.g., a logo, is preferably arranged as an element on the outside of the radar-transparent portion-for example, in the region of the outward-facing decoupling surface. Alternatively, the ornamental element may be arranged in the radar-transparent portion and/or on the inner side of the radar-transparent portion, in the region of the radar encoupling surface. Furthermore, the ornamental element may be transparent to radar radiation and/or arranged in a region in which it does not significantly impair the radar function.

According to another variant, the illumination device, in particular the radar-transparent portion, extends along a contour or shape that corresponds to the ornament. This makes the ornament visible by illuminating the illumination device as a whole.

Since the light sources are separated from the radar-transparent portion by the light-transparent cover disc, not only the cover element but also the light sources themselves are arranged outside the radar encoupling surface with respect to the optical axis. In one embodiment, no component other than the radar-transparent portion-in particular between the radar-transparent portion and a radar device—protrudes into a radar cone to be emitted. The penetration and exposure of the radar-transparent portion with the radar encoupling surface is therefore not affected by the light sources or their housings.

The optical axis of the illumination device is understood here to be the main direction of radiation of the illumination device as a whole towards the outside. The optical axis corresponds to the radiation axis of the radar radiation, wherein the emission of radar radiation and the emitted light distribution to the outside are substantially identical. In one embodiment, the optical axis of the illumination device represents an axis of symmetry around which the light sources are arranged. In addition to the optical axis of the illumination device as a whole, each of the light sources can be assigned an additional optical axis of the light sources.

According to a further development of the invention, it is provided that the light units, such as the light sources, be arranged in a respective housing which is formed partially by the at least one light-transparent cover element. The housing may be designed as an airtight closed housing, wherein the separation in terms of flow from the optical axis and the radar-transparent portion, such as the radar encoupling surface, and/or the radar unit, is realized by the cover element. The light exit region is therefore designed as an optical opening for the light exiting the housing. However, the light exit region is physically closed, at least for airflow, by the light-transparent cover element. The housing is therefore sealed at least substantially airtight by the light-transparent cover element, wherein the housing interior is at least partially delimited by the cover element. This protects the light sources from air currents. In addition, the radar-transparent portion is protected from additional heat input from the light sources and their electronics.

In addition to the cover element, the housing may include a housing base which can include several portions running at angles to each other. The cover element and the housing base, i.e., the housing as a whole, may form a closed cavity. In this regard, the region to be closed by the cover element can be comparatively small in relation to the housing base and its portions. The light source, such as an LED, which may be arranged on a circuit board, can be arranged on a first base portion of the housing base, wherein a wall portion of the housing base extends from the base portion, which runs in the direction of the radar-transparent portion and may be adjacent/fastened thereto. Alternatively, the base portion lies directly adjacent to the radar-transparent portion. This allows the housing to be adapted to other shapes of motor vehicles.

To supply power to the light source or the circuit board in the housing, a passage for electrical lines is provided in the housing wall—for example, the housing base. The power supply can also run from the inside of the housing to outside between the housing base and the cover element-for example, in that the circuit board arranged on the housing base extends to the outside of the housing between the housing base and the cover element, and the cover element lies against the circuit board so as to form a seal.

According to a further development of the invention, the illumination device may have a radar chamber and at least one ventilation opening that opens into the radar chamber, wherein the radar chamber is delimited by a radar device, the light-transparent cover element, and the radar-transparent portion. The ventilation opening and the air flowing in therethrough enable efficient cooling of the radar device.

The at least one ventilation opening can be designed to be large enough that air can enter and exit simultaneously through the same ventilation opening, so that an airflow flowing in and out of the ventilation opening can effectively flow through the radar chamber. The individual ventilation opening can be arranged at least partially, or completely, around the optical axis.

In one embodiment, several ventilation openings are provided, distributed around the optical axis and/or around the radar device. For example, at least two separate ventilation openings may be provided, located opposite each other with respect to the optical axis and/or the radar device, and may be designed and configured as a flow inlet and flow outlet. This further improves the ventilation of the radar chamber and, in particular, avoids turbulences or eddies in the region of the flow inlet and/or flow outlet.

Apart from the at least one ventilation opening, the radar chamber may be designed as closed, wherein the radar chamber is delimited in the direction of emission of the radar radiation, i.e., in a first direction of the optical axis, by the radar-transparent portion. In a second direction of the optical axis, i.e., opposite to the first direction, the radar chamber is delimited by the radar device. The radar chamber may be additionally delimited—such as laterally, i.e., in a direction perpendicular to the optical axis—by the respective housings of the light units and, in one embodiment, by a support device carrying the radar device. The ventilation opening may be formed between the housing of the light unit and/or the light-transparent cover element on one side and the radar device and/or the support device on the other such that the ventilation opening is delimited thereby. In this case, the ventilation opening is arranged on a side of the radar chamber opposite the radar-transparent portion. This ensures that the radar device is well-protected on the one hand, but also simultaneously well-ventilated without being subjected to too much air at the front, and therefore efficiently cooled during operation.

In one embodiment, the radar chamber is delimited by a decoupling surface of the radar device, via which radar radiation is emitted from the radar device in order to irradiate the radar chamber with the radar radiation, and in order for the radar radiation to impinge on the radar encoupling surface of the radar-transparent portion, for example opposite the radar device, after irradiating the radar chamber. The radar chamber may be spatially delimited overall by the radar device, the ventilation openings, the light-transparent cover element, the housing of the light unit, and the radar-transparent portion, wherein air exchange between the radar chamber and the environment is allowed only in the region of the ventilation opening.

The radar device is arranged together with the radar chamber and is designed and configured to radiate a radar radiation distribution emitted by the radar device onto the radar encoupling surface of the radar-transparent portion. The radar-transparent portion can, for example, be designed as a cover disc that is at least partially transparent to radar radiation and light. A side, oriented in the direction of the radar encoupling surface, of the radar device is preferably arranged exposed to the radar chamber and facing it.

The support device can be designed as a portion of a radiator grille. In one embodiment, the support device may be mechanically connected to the housing of the light unit via at least one connecting element and/or formed integrally therewith as a support housing, wherein the integral support housing has the air inlet opening between a support portion carrying the radar device and a housing portion encompassing the housing. This increases stability and simplifies the construction.

In one embodiment, the radar device may be fastened to the in particular grid-or plate-shaped carrier device, wherein at least two fastening elements fix the radar device to the carrier device. Additionally, a plug connection of the radar device may extend through the carrier device to enable a power supply and/or signal transmission from and to the radar device.

Alternatively, there is at least no direct mechanical connection or a detachable mechanical connection between the housings of the light units and support device, which allows for a more flexible arrangement and—for repair and maintenance purposes—easy access to the radar device.

According to a further development of the invention, it is provided that the light-transparent cover element spatially separate the respective housing interiors of the housing of the light units on one side from the radar chamber on the other, such as the radar encoupling surface, the radar-transparent portion, and/or the radar device. This protects the housing interior from an airflow flowing through the radar chamber.

The light-transparent cover element can be disc-shaped and separates the radar chamber from the interior of the housing in terms of flow such that air exchange between the housing interior and the radar chamber is at least weakened, or completely prevented. For this purpose, the cover element, so as to from a seal, lies against the adjacent elements at its edges, such as the radar-transparent portion and/or the housing base of the light units. For sealing, the light-transparent cover element has a sealing structure and/or a sealing element in its surrounding edge region. In one embodiment, the light-transparent cover element lies against the rest of the housing so as to from a seal, for example with respect to the housing base along a closed circumferential line around the cover element. This protects the light unit, in particular its light source and/or circuit board or other electronic components in the housing, from air currents and the associated damage.

Alternatively or additionally, the radar-transparent portion lies against the light-transparent cover element and/or the housing so as to from a seal to prevent air exchange between the environment and the radar chamber delimited by the radar-transparent portion in this region.

According to a further-developed embodiment of the invention, the light-transparent cover element may be designed as a two-component assembly, wherein the two-component assembly has a sealing, elastic portion, in particular the sealing element, and a rigid portion for light transmission. In this case, at least the rigid portion is designed to be transparent to light. The sealing, elastic portion can be transparent or opaque and surrounds at least partially, or completely, the outer, circumferential edge of the cover element. This creates a reliable seal between the inside of the housing and the radar chamber.

Further, the light-transparent cover element overall may be arranged at a distance from the radar-transparent portion. In this case, the radar-transparent portion abuts directly against a housing portion of the housing, such as a housing wall, in order to secure the radar-transparent portion on the one hand and to prevent air from passing through in this region on the other.

Furthermore, the light source and the light-transparent cover element may be designed and arranged such that the light passing through the cover element is emitted in the direction of the radar-transparent portion. This ensures good visibility of the ornament.

According to a further development of the invention, opposing side surfaces of the cover element may run at least partially continuously and/or parallel to each other. This prevents disturbances, especially unwanted reflections, during light transmission.

In one embodiment, the entire region of the cover element, which is irradiated by a light distribution emanating from the light source, which-depending upon the relative geometric arrangement of the light source to the cover element and further to the light encoupling surface—may be coupled into the radar-transparent portion at the encoupling surface in the further beam path, may be designed to be continuous. The light-transparent cover element may be designed in a disc shape, at least partially, particularly in this continuously extending region. The light-transparent cover element, in particular its side surfaces, especially an inside and an outside of the cover element, therefore exhibit a continuous profile in the region of light transmission. This creates precise optical conditions and avoids disturbing reflections.

According to a further development of the invention, it is provided that the light unit comprise a reflector element for reflecting the light emitted by the light source in the direction of the light-transparent cover element, wherein the reflector element is arranged inside the housing and/or delimits it. The light emanating from the light source therefore at least partially hits the reflector element first and is reflected thereby onto the light-transparent cover element. Greater brightness and efficiency can thereby be achieved.

In one embodiment, the reflector element may extend from the housing base in the direction of the cover element and lies against the cover element at its end facing away from the housing base. In one embodiment, the cover element may extend on the reflective side of the reflector element, which faces the light source continuously from this contact point to the contact region of the cover element on the housing base.

According to a further development of the invention, it is provided that the reflector element, starting from a housing base to which the light source may be attached, at least indirectly, via the circuit board, extend to the light-transparent cover element, such that the housing base, the reflector element, and the cover element form the housing, which is enclosed.

The reflector element can function here as a wall that delimits the housing interior. For this purpose, it is provided that the reflector element at its edges lie against the housing base and the cover element, so as to from a seal, such that the space of the light unit, which is separated from the radar chamber and enclosed, is formed between the reflector element, the cover element, and the housing base. This means that additional housing elements are not strictly necessary.

Alternatively, the reflector element is arranged inside the enclosed space so that the reflector element does not form a wall delimiting the housing interior.

In one embodiment, the reflector element is designed as a separate component from the light-transparent cover element.

According to a further development of the invention, the reflector element may be formed by a reflective coating, wherein a portion, directed toward the light source, of the light-transparent cover element has the reflective coating. This ensures the reflectivity of the reflector element achieves high radiation efficiency, and prevents heating in the housing caused by radiation absorption.

To reflect the incoming radiation, one side, facing the light source, of the reflector element is designed to be reflective, wherein a reflective coating is applied to the reflector element, and/or the reflector element itself is designed to be reflective.

The reflective coating or reflective surface of the reflector element is oriented on one side in the direction of the light source and on the other side in the direction of the cover element. It may indeed happen and be desired that the cover element cause a further deflection of the beam path. Nevertheless, the reflective coating or reflective surface may also be aligned in the direction of the optical axis and/or the radar-transparent portion in order to thereby achieve a high light intensity or efficiency.

According to an alternative embodiment, the reflective coating may be applied to a coating element, which may be made of the same material as the covering element. The coating element in this case may be designed as a one-piece extension of the cover element. The reflective coating is therefore arranged on an inner side of the cover element, wherein the inner side lies opposite the light exit region and faces it and the light source. The cover element therefore comprises two portions: firstly, the light-transparent portion which spatially closes the light exit region, and secondly, the reflective portion which is opposite the light exit region. By using the cover element as a reflector element, a separate reflector element can therefore be dispensed with. This can also simplify the sealing process, since a sealing connection need be created only between the housing base and/or circuit board on one side and the cover element on the other.

According to a further development of the invention, it is provided that the light-transparent cover element may be designed as a solid body with a totally reflective wall. This prevents reflection losses at the reflector element. Furthermore, the reflector element can be completely dispensed with, such that, overall, fewer components are required for the construction.

The totally reflective wall is arranged analogously to the alternative reflector element, so that totally reflected light radiation is emitted in the direction of the light-transparent cover element.

The totally reflective wall is one facing the light source, i.e., the inward-facing wall of the outer side of the solid, light-transparent cover element, wherein this wall lies opposite the light exit region and therefore the light-transparent portion of the cover element. In this case, the light can therefore initially enter the cover element on the inner side, facing the light source, of the solid cover element and is totally reflected on the opposite, outer side of the cover element, in order to then exit the cover element in the region of the light exit region and be emitted in the direction of the radar-transparent portion.

The totally reflective wall is arranged relative to the light source, and the solid cover element is designed such that the necessary conditions for total reflection are met.

Alternatively or additionally, an inward-reflective coating can be applied to the outside of the solid body. This allows radiation losses, such as those caused by angles when total reflection conditions are violated, to be compensated for.

As mentioned, the light unit may have a circuit board and an LED arranged thereon, wherein the circuit board may be attached to the housing base. The circuit board and/or electrical supply lines are guided through sealed openings, along the housing base.

Furthermore, the light-transparent cover element may have at least one optically effective structure, such as a prism, a diverging lens, and/or a converging lens.

According to a further development of the invention, the light-transparent cover element may have a matting on its outer side. This allows unwanted light transmission through the cover element to be reduced and/or converted into diffuse radiation.

In one embodiment, the matting may be formed in a boundary region of the cover element which adjoins the housing and/or the reflector element, and/or in the region of a discontinuous point of the cover element. Otherwise, disturbing reflections can occur in this region in particular, which can impair the visibility of the ornament. Such reflections are prevented by the matting.

The matting can be provided both in embodiments with a solid cover element and total reflection, and in embodiments with a disc-shaped cover element and/or separate reflector element.

Other advantages of the invention will be readily appreciated as the same becomes better understood by reference to the following detailed description when considered in connection with the accompanying drawings, wherein:

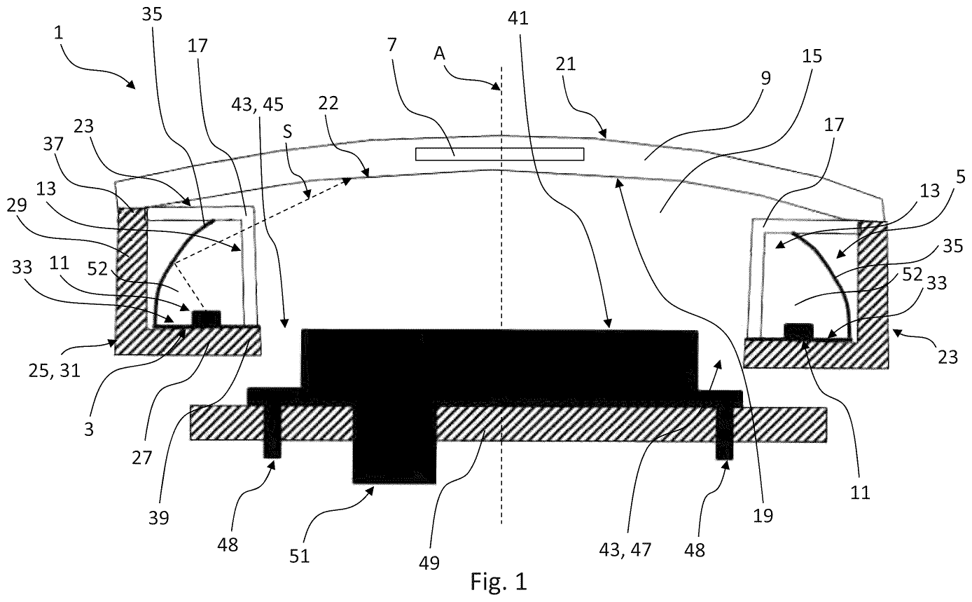

FIG. 1 shows a first exemplary embodiment of an illumination device in a lateral sectional view;

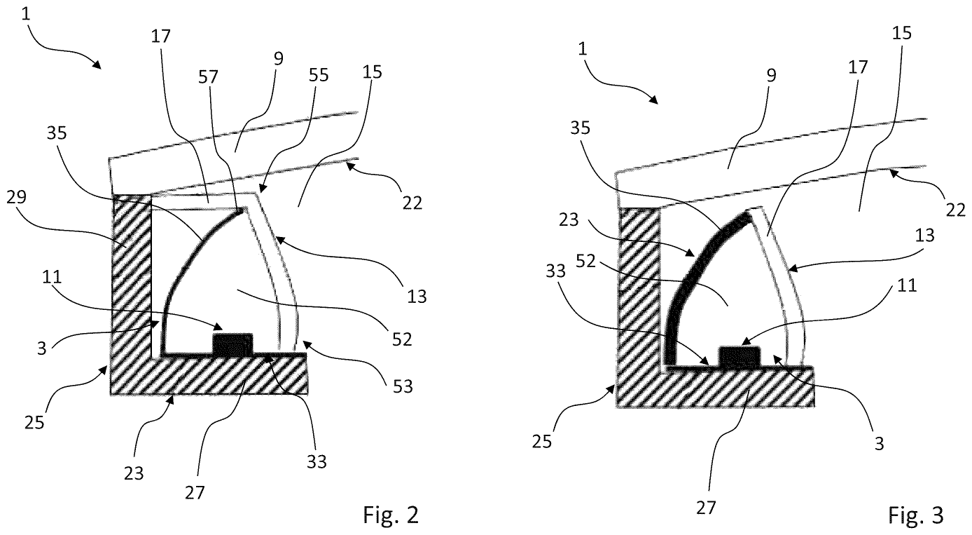

FIG. 2 shows a cutout of the illumination device according to a second exemplary embodiment;

FIG. 3 shows a cutout of the illumination device according to a third exemplary embodiment;

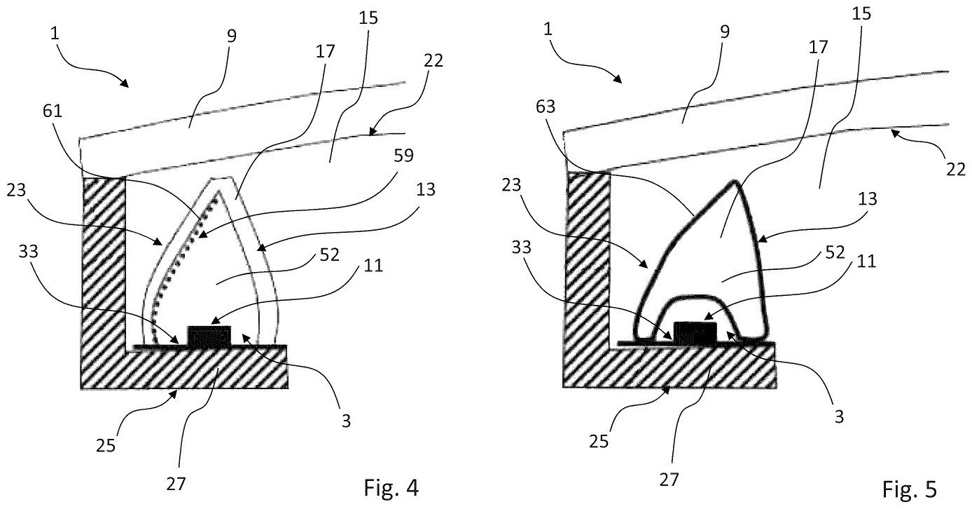

FIG. 4 shows a cutout of the illumination device according to a fourth exemplary embodiment;

FIG. 5 shows a cutout of the illumination device according to a fifth exemplary embodiment;

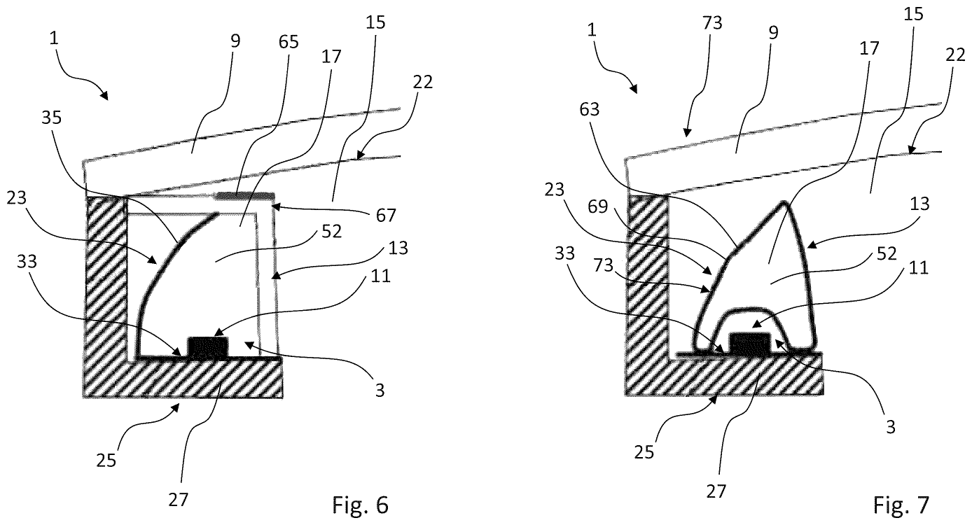

FIG. 6 shows a cutout of the illumination device according to a sixth exemplary embodiment; and

FIG. 7 shows a cutout of the illumination device according to a seventh exemplary embodiment.

### DETAILED DESCRIPTION OF THE INVENTION

FIG. 1 shows an illumination device 1 with a plurality of light units, of which a first light unit 3 and a second light unit 5 in particular are recognizable in FIG. 1. The illumination device 1 is designed and configured to display an ornament 7 which, for example, may be incorporated into a radar-transparent portion 9 or applied thereto, visible to human observers. In this case, ornament 7 may be designed as a separate ornamental element-for example, in the form of a logo.

The two light units 3, 5 each have a light source 11 for generating light and a light exit region 13 via which the generated light can shine into a region outside the respective light unit 3, 5, such as into a radar chamber 15.

The light exit region 13 is closed by a light-transparent cover element 17, which prevents a physical exchange of, for example, air masses between the radar chamber 15 and the interior of the light units 3, 5. Since the cover element 17 is designed to be transparent, the light generated by the light source 11 can pass through the cover element 17.

In this case, the light-transparent cover element 17 is arranged outside a radar encoupling surface 19 with respect to an optical axis A of the illumination device 1. The radar encoupling surface 19 is provided by the radar-transparent portion 9 and serves to couple radar beams into the radar-transparent portion 9. On the opposite, outward-facing side of the radar-transparent portion 9, a corresponding decoupling surface 21 is provided through which the encoupled radar beams are decoupled and emitted into the environment. The decoupling region 21 and therefore the outside of the radar-transparent portion 9 corresponds to the outside of a motor vehicle. The radar-transparent portion 9 in this case is at least semi-transparent to light. The ornament is thereby visibly displayed to the outside when the light sources are in operation, and, at the same time, a radar function for the motor vehicle is created.

Furthermore, the radar-transparent portion 9 has a light encoupling surface 22 for encoupling the light generated by the light sources 11. The decoupling surface 21 serves not only to decouple the radar radiation, but also to decouple the light. Therefore, depending upon the light coupled into the radar-transparent portion 9, a light distribution is emitted outwards, whereby the at least one ornament 7 is represented.

The dependence upon the encoupled light means, for example, that the perceptibility of the ornament 7 changes when the light sources 11 are switched off or when a spectral composition, in particular a color, of the emitted light is changed. However, other measures influencing the light path from the light sources 11 to the decoupling surface 21, such as a matting in the visible spectral range or reduced optical transparency of the radar-transparent portion 9 and/or the cover element 17, can accordingly change the representation of the ornament 7.

The light encoupling surface 22 can be designed to overlap the radar encoupling surface 19 at least partially, and also completely. Alternatively, it is also possible for the surfaces to be arranged completely separately from each other.

The light units 3, 5 are arranged in a respective, closed housing 23. The housing is formed partially, in particular in the region of the light exit region 13, by the light-transparent cover element 17. Furthermore, the housing has a housing base 25 with a base portion 27 and a lateral wall portion 29, which—as shown in FIG. 1—can merge into each other at a right angle. The housing base 25 is designed here as a one-piece housing base element 31. Alternatively, it is also possible to design the housing base 25 in multiple parts. In FIG. 1, in the side view, the housing 23 creates a rectangular housing 23, which protects the light source 11 arranged in the interior and other elements arranged therein, such as a circuit board 33 and a reflector element 35. This prevents an airflow flowing through radar chamber 15 from being able to advance to the light sources.

An exemplary beam path S of the light generated by the light source 11 is shown in FIG. 1 with a dashed arrow, which is reflected at the reflector element 35 and then leaves the interior of the housing 23 via the light exit region 13, passing through the light-transparent cover element 17, entering the radar chamber 15, and hitting the light encoupling surface 22 there.

The cover element 17 lies against an upper end 37, facing the radar-transparent portion 9, of the housing base element 31 on the wall portion 29. At a second end 39 of the housing base element 31, the cover element 17 lies against the base portion 27. Inside and opposite to the image plane, the cover element also lies against the housing base-for example, in that, in and against the viewer's direction of view to the base portion 27 and the wall portion 29, a boundary wall extends perpendicular thereto and/or substantially parallel to the image plane and can be part of the cover element and/or part of the housing base. This protects the light units 3.5 from air currents and at least reduces heat exchange with the radar chamber 15. This allows each light unit 3, 5 to be assigned its own housing, wherein the respective, own housings 23 are also spatially separated from each other.

According to an alternative embodiment, the light-transparent cover element 17 and the housing base 25 can extend at least partially, or completely, around the optical axis A. This may be advantageous if the radar chamber 15 has a substantially round cross-section. In this case, the housing base 25 also extends around the optical axis A in order to thereby form an interior of the housing surrounding the optical axis A. This eliminates the need for boundary walls, which allows material to be saved.

Furthermore, it can be seen in FIG. 1 that the radar chamber 15 may be delimited by the radar-transparent portion 9, the housing 23, such as the light-transparent cover element 17, and a radar device 41. In this case, a ventilation opening 43 is formed between the radar device 41 and the housing 23, for example the base portion 27, to allow an airflow into the radar chamber 15 and out of it. This allows the radar unit 41 to be cooled.

In one embodiment, at least two ventilation openings 43, such as a first ventilation opening 45 and a second ventilation opening 47, are provided. The respective ventilation opening 43, 47 runs at least partially between the radar device 41 and a respective light unit 3, 5.

Through the ventilation openings 43, 47, a flow path can be defined by further flow guiding elements in the flow path, e.g., one-way valves in the ventilation openings, and/or a suitable arrangement of a flow inlet, such that the ventilation opening 45 acts as a flow inlet and the second ventilation opening 47 as a flow outlet.

The radar device 41 is attached to a support device 49 by two fasteners 48—such as, for example, screws. The carrier device 49 can be a body or a support frame of a vehicle or a support wall of a radiator grille component.

In a first example, the base portion 27 is connected to the radar device 41 via rigid connecting mechanisms not shown in FIG. 1. In a second example, the base portion 27 is independently connected to the support device 49. In a third example, the base portion 27 is connected to another component of the motor vehicle.

In addition, for the signal transmission and/or power supply of the radar device 41, a plug connection 51 is provided, via which the radar device 41 can be controlled.

The radar device 41 and the radar chamber 15 are spatially separated from the housing interior 52 of the housing 23, wherein at least the light-transparent cover element 17 acts as a physical partition. The thermal insulation between the housing 23 and the radar device 41 is further enhanced by the ventilation openings and the thereby produced airflow between the housing 23 and the radar device 41. At the same time, the spatial separation prevents the light units 3, 5 or the optical display quality from being affected by the airflow.

FIGS. 2 to 7 below show a cutout of the representation shown in FIG. 1 for further embodiments. The shown cutout is limited to the first light unit 3, a portion of the radar chamber 15, and the radar-transparent portion 9.

FIG. 2 shows another embodiment, wherein the light-transparent cover element 17 extends between the first, upper end and the second, lower end of the housing base 25. Unlike in FIG. 1, the opposing and parallel-running side surfaces of the cover element 17 extend over the entire region of the light exit region 13 between an end 53, facing the housing base 23, of the cover element 17, which also represents a first, for example, lower end of the light exit region 13, and a second, for example, upper end 55 of the light exit region 13 which is defined by the course of the reflector element 35, such as its end 57 distal from the housing base. In one embodiment, the reflector element abuts the cover element 17. This avoids disturbing light reflections at discontinuous points of the cover element 17, whereby the overall outer appearance of the ornament and the illumination device is enhanced and more easily recognizable.

FIG. 3 shows another embodiment, wherein the reflector element 35 constitutes a boundary of the housing interior 52. The reflector element 35 together with the cover element 17 and the circuit board 33 and/or the housing base 23 form the closed housing 23 or its walls, wherein the light unit 3 is arranged in the interior of the housing 23. The cover element 17 is therefore attached only at one end to the housing base 23, on which the circuit board 33 with the light source is arranged, while it delimits the reflector element 35 laterally (into and out of the image plane in the figure) and further upwards in the figure, i.e., in the direction of the radar-transparent portion 9. This allows the cover element 17 to be shaped more compactly and the overall shape of the light unit and the housing 23 to be designed independently of other components.

FIG. 4 shows another embodiment, wherein the reflector element 35 is formed by a reflective coating 59. The reflective coating 59 is applied in this case to a surface 61 oriented in the direction of the light source. The surface in this case can, as shown in FIG. 4, be a surface 61 of the cover element 17. The cover element 17, together with the circuit board 33 and/or the housing base, forms the enclosed interior of the housing 23.

FIG. 5 shows another embodiment, wherein the light-transparent cover element 17 is designed as a solid body with a totally reflective wall 63 and is accordingly arranged relative to the light source 11 to meet the necessary conditions of total reflection. The material of which the solid body consists is also selected such that total reflection can take place on the wall 63, in particular at a transition to an air-filled region. A first part of the light from the light source 11 coupled into the cover element 17 is reflected at the wall 63 toward the light exit region 13. A second part of the light from the light source 11 coupled into the cover element 17 is guided directly in the direction of the light exit region 13 and there decoupled from the cover element 17.

In this case, the light unit 3 and the light source 11 are enclosed in the region between the solid body of the light-transparent cover element 17 and the circuit board and/or the housing base 25, and are therefore protected from air currents. Accordingly, the housing 23 is predominantly formed here by the cover element 17, which has on its side facing the light source a concave recess, in which the light source is received, while the cover element sits on an in particular flat surface which is provided by the circuit board 33 and/or the housing base 25. In this embodiment, the housing 23 is therefore also formed by the cover element 17, the circuit board 33, and/or the housing base 25.

FIG. 6 shows another exemplary embodiment, wherein the light-transparent cover element 17 has a regional matting 65. The matting 65 can be achieved by a coating or a separate element which is applied to the cover element 17. Alternatively, the matting 65 can also be created by a surface structure of the cover element 17 different from other regions of the cover element 17. This avoids distracting reflections, so that the overall visibility of the ornament is improved.

As in the exemplary embodiments shown in FIGS. 1 and 2, the illumination device 1 in FIG. 6 also has the separate reflector element 35, wherein in particular a region of the cover element is provided here with the matting, which leads from the reflector element 35 to a discontinuity 67 in the course of the cover element 17. This limits the non-matted region of the cover element 17 to the continuously running region, which improves the overall appearance and, by the matting 65, reduces the disturbing reflections that can occur through the angled, matted region.

FIG. 7 shows another exemplary embodiment which results from a combination of features that were explained with reference to the exemplary embodiments shown in FIG. 5 and FIG. 6: on the one hand, in FIG. 7, the cover element 17 is designed as a solid body which is arranged on the circuit board 33. Alternatively or additionally, it is possible that the cover element 17 be arranged at least partially, and also completely, on the housing base 25. Electronic supply lines and/or the circuit board 33 can, for example, also be routed through the housing base 25.

On the other hand, in FIG. 7, as in FIG. 6, a matting is provided which here is arranged opposite the light exit region 13, i.e., on that side of the cover element 17 facing away from the radar chamber 15, on a rear side 71 of the cover element 17. In this case, the matting 65 is located in the region of a discontinuity and/or in the region of the totally reflective wall 63. This can prevent light beam paths in the outer edge region 73 of the radar-transparent portion 9, which would lead to a more inhomogeneous appearance toward the outside or would worsen the visibility of the ornament 7.

The matting is provided on a large part, in particular the entire rear side 71 of the cover element 17, in order to avoid as much interference radiation as possible in the edge region 73.

The invention has been described in an illustrative manner. It is to be understood that the terminology which has been used is intended to be in the nature of words of description rather than of limitation. Many modifications and variations of the invention are possible in light of the above teachings. Therefore, within the scope of the appended claims, the invention may be practiced other than as specifically described.

1. An illumination device for a motor vehicle, for the visible display of at least one ornament, the illumination device comprising:
a plurality of light units with light sources for generating light and with at least one light exit region wherein at least one light-transparent cover element closes the at least one light exit region wherein the light-transparent cover element, with respect to an optical axis (A) of the illumination device is arranged outside a radar encoupling surface of at least one radar-transparent section for encoupling radar beams; and
the at least one radar-transparent section with the radar encoupling surface for encoupling the radar radiation, with at least one light encoupling surface for encoupling the light emitted by the light units and with a decoupling surface for decoupling the encoupled radar radiation and for emitting a light distribution which represents the at least one ornament, depending upon the light coupled into the radar-transparent portion via the light encoupling surfaces.

2. The illumination device as set forth in claim 1, wherein the light units, in particular the light sources, are arranged in a respective housing which is formed partially by the at least one light-transparent cover element.

3. The illumination device as set forth in claim 1, wherein the illumination device has a radar chamber and at least one, preferably two, ventilation opening(s) opening into the radar chamber, wherein the radar chamber is delimited at least by a radar device the light-transparent cover element and the radar-transparent portion.

4. The illumination device as set forth in claim 2, wherein the light-transparent cover element spatially separates the respective housing interior of the housings of the light source on one side from the radar chamber on the other, in particular the radar encoupling surface, the radar-transparent portion and/or the radar device.

5. The illumination device as set forth in claim 1, wherein opposite side surfaces of the cover element extend at least partially continuously and/or parallel to each other.

6. The illumination device as set forth in claim 2, wherein the light unit comprises a reflector element for reflecting the light emitted by the light source in the direction of the light-transparent cover element, wherein the reflector element is arranged inside the housing and/or delimits it.

7. The illumination device as set forth in claim 2, wherein the reflector element extends from a housing base to which the light source is attached, to the light-transparent cover element such that the housing base the reflector element, and the cover element form the in particular enclosed housing.

8. The illumination device as set forth in claim 1, wherein the reflector element is formed by a reflective coating, wherein a portion, directed in the direction of the light source of the light-transparent cover element has the reflective coating.

9. The illumination device as set forth in claim 1, wherein the light-transparent cover element is designed as a solid body with a totally reflective wall.

10. The illumination device as set forth in claim 1, wherein the light-transparent cover element has a matting on its outside.
